(19) United States
(12) Patent Application Publication
(10) Pub. No.: US 2024/0251040 A1
(43) Pub. Date: Jul. 25, 2024

(54) POWER MANAGEMENT OF DOORBELL SYSTEMS

(71) Applicant: Comcast Cable Communications, LLC, Philadelphia, PA (US)

(72) Inventors: Gary Michael REKSTAD, JR., Philadelphia, PA (US); Vijayanand DUBEY, Downingtown, PA (US); Joseph FRANK, Medford, NJ (US); Uday Krishna GARPATHI, Downingtown, PA (US); Benny J. PRUDEN, Brownstown, PA (US); Joseph RODOLICO, Nokomis, FL (US); Christopher STONE, Newtown, PA (US); David URBAN, Cinnaminson, NJ (US)

(21) Appl. No.: 18/156,563

(22) Filed: Jan. 19, 2023

(51) Int. Cl. H04M 11/02; H02J 7/00; H04M 1/72412; H04N 7/18

(52) U.S. Cl. CPC H04M 11/025; H02J 7/007; H04M 1/72412; H04N 7/186

(57) ABSTRACT

Systems, methods, and apparatuses for power management of doorbell systems are described herein. A doorbell system comprising at least a camera and a chime may cause a connection to be established. The connection may be established between the camera at least one user device. A first indication to cause the chime to output a first audio notification may be received. Based on determining that the connection is established between the camera and the at least one user device, prevention of outputting the first audio notification by the chime may be caused.

### BACKGROUND

A doorbell system may comprise one or more power sources and a doorbell device. The power source(s) may provide power to various components of the doorbell device. The components may include, for example, a camera, audio feedback component(s), visual feedback component(s), light-emitting diodes (LEDs), camera heater(s), filter(s), and/or the like. The power source(s) may not have the capacity to power multiple of these components at the same time. Thus, techniques for power management of doorbell systems are desirable.

### SUMMARY

Methods and systems for power management of doorbell systems are described herein. A doorbell system may comprise a doorbell device and a chime. The doorbell device may comprise a camera and a button. If the button is pressed, the chime may be caused to ring (e.g., output an audio notification). To cause the chime to ring, the camera may be switch from an AC power source to a battery power source. Switching the camera to the battery power source may ensure that the AC power source has the capacity to provide sufficient power to the chime to cause the chime to ring. A connection may be established between the camera and a user device. The battery power source may not have the capacity to maintain the connection between the camera and the user device and output an audio notification. Thus, if the connection is established between the camera and a user device, the chime may be prevented from outputting audio notifications. Preventing the chime from outputting audio notifications may prevent the camera from switching to the battery power source while the connection is established.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to features that solve any or all disadvantages noted in any part of this disclosure.

### BRIEF DESCRIPTION OF THE DRAWINGS

The following detailed description is better understood when read in conjunction with the appended drawings. For the purposes of illustration, examples are shown in the drawings; however, the subject matter is not limited to specific elements and instrumentalities disclosed. In the drawings:

FIG. 1 shows an example system.

FIG. 2 shows example communication framework.

FIG. 3 shows an example method for power management.

FIG. 4 shows an example method for power management.

FIG. 5 shows an example method for power management.

FIG. 6 shows an example method for power management.

FIG. 7 shows an example method for power management.

FIG. 8 shows an example method for power management.

FIG. 9 shows an example method for power management.

FIG. 10 shows an example computing device.

### DETAILED DESCRIPTION OF ILLUSTRATIVE EMBODIMENTS

A doorbell system may comprise a doorbell device and a chime. The doorbell device may comprise a plurality of components. The components may comprise, for example, a camera, a chime, a button, light-emitting diodes (LEDs), camera heater(s), infrared (IR) LEDs, an infrared cut removable (ICR) filter, audio inputs (e.g., microphones), audio outputs (e.g., speakers), and/or the like. The components may receive power from one or more power sources. The power sources may comprise an alternating current (AC) power source and/or a battery power source.

A doorbell device may rely on an AC power source to provide power to the camera until the button is pressed (e.g., by a user). If the button is pressed, the camera may switch to relying on a battery power source. Switching the camera to rely on the battery power source may ensure that the AC power source has the capacity to provide sufficient power to the chime to cause the chime to ring (e.g., output an audio notification). The camera may switch back to the AC power source if the output of the audio notification is complete.

However, the battery power source may only have the capacity to power the camera for a short duration (e.g., just long enough for the chime to emit one or two audio notifications) before being recharged. The battery may not have the capacity to simultaneously power both the camera and one or more other components of the doorbell device (e.g., the camera heater(s), IR LEDs, the ICR filter, audio inputs, audio outputs, etc.). If the camera and other component(s) of the doorbell device simultaneously attempt to draw power from the battery power source, the peak power capability of the battery power source (e.g., the maximum power that the battery power source can sustain for a short time) may be exceeded. Exceeding the peak power capability of the battery power source may adversely impact the life of the battery power source, cause the doorbell device to reboot, and/or may damage the doorbell device.

A doorbell device may rely on an AC power source to power its components. A transformer may be connected to the AC power source. The transformer may have a power rating that does not allow multiple components of the doorbell device to be simultaneously powered without a voltage drop. Such a voltage drop may cause an undesirable forced reboot (e.g., restart) of the camera. Thus, if multiple components of the doorbell device simultaneously receive power from the AC power source through the transformer, the camera may be forced to reboot. Accordingly, improved methods and systems for power management of doorbell systems are desirable. Described herein are methods and systems for preventing multiple components of the doorbell device from simultaneously receiving power from the AC power source through the transformer, while still maintaining the functionality of the doorbell device. Preventing multiple components of the doorbell device from simultaneously receiving power from the AC power source through the transformer may prevent an undesirable forced reboot of the camera.

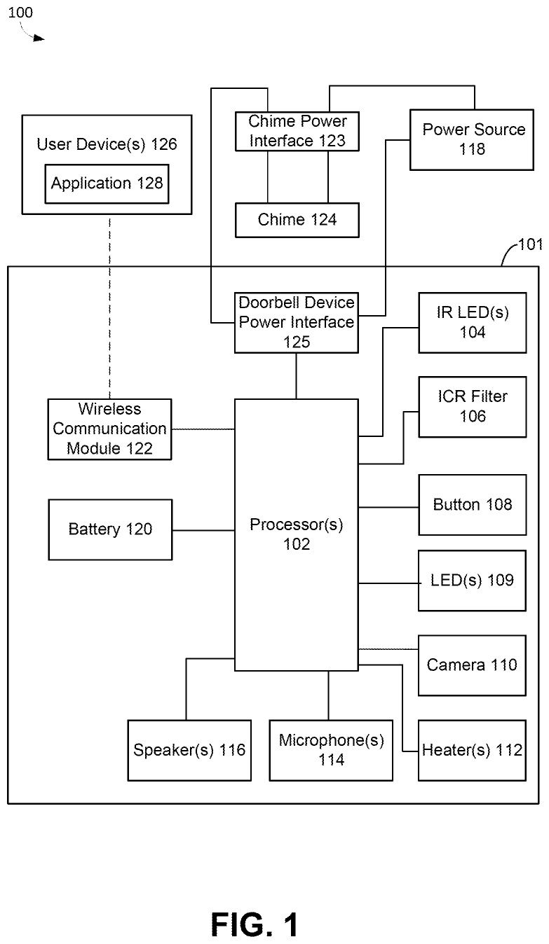

FIG. 1 shows a block diagram of an example doorbell system 100. The doorbell system 100 may comprise a doorbell device 101, a power source 118, a chime 124, and one or more user device(s) 126. The doorbell device 101 may be located outdoors at a premises (e.g., outside of a building, house, etc.). The chime 124 may be located indoors at the premises (e.g., inside of the building, house, etc.). The user device(s) 126 may be located either external to the premises or at the premises (outdoors or indoors).

The power source 118 may be a power source external to the doorbell device 101. The power source 118 may be configured to provide alternating current (AC). For example, the power source 118 may provide AC power to one or more components of the doorbell device 101 and/or to the chime 124. The doorbell system 100 may comprise a transformer. The transformer may be connected to the power source 118. The transformer 118 may for example, be a step-down transformer. The component(s) of the doorbell device 101 and/or the chime 124 may draw power from the power source 118. For example, one or more of the components within the doorbell device 101 and/or the chime 124 may draw power from the power source 118 through the transformer. A voltage output of the transformer may decrease as higher current is drawn from the transformer.

The doorbell device 101 may comprise a housing (not shown) that encloses a processor 102. The processor 102 may be electrically connected to the power source 118, such as via a doorbell device power interface 125. The processor 102 may be electrically connected to the chime 124, such as via the doorbell device power interface 125 and a chime power interface 123. The doorbell device 101 may comprise a plurality of components. The plurality of components may be electrically connected to the processor 102. The plurality of components may comprise one or more of a wireless communication module 122, a button 108, LEDs 109, a camera 110, one or more camera heaters 112, infrared (IR) LEDs 104, an infrared cut removable (ICR) filter 106, one or more audio inputs (e.g., microphones) 114, one or more audio outputs (e.g., speakers) 116, or a battery 120. The plurality of components of the doorbell device 101 may be configured to draw power from the power source 118.

The wireless communication module 122 may be configured to communicate with one or more devices external to the doorbell device 101. The wireless communication module 122 may be configured to communicate with the device(s) external to the doorbell device 101 via a wireless communication method (e.g., Wi-Fi, Bluetooth, Zigbee, etc.). For example, the wireless communication module 122 may be configured to communicate with the chime 124 and/or the user device(s) 126 via a wireless communication method.

The button 108 may be located outside of the housing of the doorbell device 101. The button 108 may be configured to cause the chime 124 to output a notification if the button 108 is actuated (e.g., pressed). The chime 124 may be an electronic chime with a speaker and/or a mechanical chime. The chime 124 may comprise an electro-mechanical device, such as an electro-mechanical device with no chips, controllers, etc. If the button 108 is pressed (e.g., by a user), audio feedback may be output via the speaker(s) 116. Output of the audio feedback may indicate that the button 108 was successfully pressed. If the button 108 is pressed, the processor 102 may receive an indication to cause the chime 124 to output an audio notification. Additionally, or alternatively, if the button 108 is pressed, the processor 102 may receive an indication to send a notification to the user device(s) 126.

The processor 102 may cause the chime 124 to output the audio notification. The processor 102 may cause the chime 124 to output the audio notification based on receiving the indication to cause the chime 124 to output the audio notification. To cause the chime 124 to output the audio notification, the processor 102 may send an electrical signal to the chime 124. The chime 124 may output the audio notification based on receiving the electrical signal from the processor 102. Additionally, or alternatively, to cause the chime 124 to output the audio notification, the processor 102 may send an electrical signal to the wireless communication module 122. The wireless communication module 122 may send a wireless signal to the chime 124 based on receiving the electrical signal from the processor 102. The chime 124 may output the audio notification based on receiving the wireless signal from the wireless communication module 122.

The processor 102 may cause a notification to be sent to the user device(s) 126 based on receiving the indication to send the notification to user device(s) 126. To cause the notification to be sent to the user device(s) 126, the processor 102 may send an electrical signal associated with the notification to the wireless communication module 122. The wireless communication module 122 may send the notification to the user device(s) 126 based on receiving the electrical signal from the processor 102. The wireless communication module 122 may send the notification to the user device(s) 126 via a wireless communication method. The user device(s) 126 may output the notification. The notification may comprise a message, a push notification, an alert in an application, an audio notification, and/or a combination thereof.

The camera 110 may be configured to generate camera data. The camera data may include still images and/or video of a field of view in front of the camera 110. The camera data may include one or more video frames captured by the camera 110. For example, the camera data may include a live video stream and/or video clips captured by the camera 110. The camera data may include one or more images captured by the camera 110.

The camera heater(s) 112 may be configured to generate heat. For example, the camera heater(s) 112 may be configured to generate heat if the battery temperature and/or camera temperature is below (e.g., does not satisfy) a predetermined threshold. If the battery temperature and/or camera temperature is below a predetermined threshold, this may indicate that the camera 110 is at risk of being too cold to properly function. The processor 102 may for example, be configured to determine if the battery temperature and/or camera temperature is below the predetermined threshold. If it is determined that the battery temperature and/or camera temperature is below the predetermined threshold, the processor 102 may cause (e.g., instruct) the camera heater(s) 112 to generate heat. The heat generated by the camera heater(s) 112 may be utilized to warm up (e.g., increase the temperature of) the camera 110. Warming up the camera 110 may prevent the camera 110 from malfunctioning when it is cold outside.

The IR LEDs 104 may be configured to illuminate the field of view of the camera 110. The IR LEDs 104 may be configured to illuminate the field of view of the camera 110 using infrared light, for example. The IR LEDs 104 may be configured to illuminate a field of view of the camera 110 if the level of natural light is low (e.g., at night).

The processor 102 may be configured to control (e.g., turn on, turn off, and/or adjust brightness of) illumination of the IR LEDs 104. For example, the processor 102 may be configured to determine that the level of natural light is below a predetermined threshold. If the processor 102 determines that the level of natural light is below a predetermined threshold, the processor 102 may cause the IR LEDs 104 to illuminate a field of view of the camera 110. The processor 102 may be additionally or alternatively be configured to determine that the level of natural light has increased to meet or exceed the predetermined threshold (e.g., the processor 102 may determine that it is daytime). If the processor 102 determines that the level of natural light meets or exceed the predetermined threshold, the processor 102 may cause the IR LEDs 104 to turn off. The processor 102 may additionally or alternatively be configured to adjust an illumination level (e.g., brightness) of the IR LEDs 104 based on a level of the natural light. For example, the processor 102 may cause the illumination level of the IR LEDs 104 to increase as the level of natural light falls further below the predetermined threshold.

The ICR filter 106 may be a physical filter configured to block out infrared light. The ICR filter 106 may be physically moved (e.g., by the processor 102) into a first position or a second position. In the first position, the ICR filter 106 may be positioned between a lens of the camera 110 and an image sensor of the camera 110. The ICR filter 106 may be moved into the first position if it is determined that a level of natural light meets or exceeds the predetermined threshold (e.g., if it is determined that it is daytime). It may be determined that the level of natural light meets or exceeds the predetermined threshold by the processor 102, for example. If the ICR filter 106 is in the first position, the ICR filter 106 may be configured to block (e.g., filter) out infrared light that enters through the lens of the camera 110. Blocking out infrared light that enters through the lens of the camera 110 may improve the image and/or video quality of the field of view captured by the camera 110.

In the second position, the ICR filter 106 is not positioned between the lens of the camera 110 and the image sensor of the camera 110. The ICR filter 106 may be moved into the second position if it is determined that level of natural light has fallen below (e.g., does not satisfy) the predetermined threshold (e.g., if it is determined that it is nighttime). It may be determined that the level of natural light does not satisfy the predetermined threshold by the processor 102, for example. If the ICR filter 106 is in the second position, the ICR filter 106 may not be configured to block (e.g., filter) out infrared light that enters through the lens of the camera 110.

Causing movement of the ICR filter 106 may require a large quantity of power to be drawn from the power source 118 and/or from the battery 120. To ensure that enough power is available to cause movement of the ICR filter 106, the capability of the camera heater(s) 112 may be disabled if it is time to move the ICR filter 106. Additionally, or alternatively, to ensure that enough power is available to cause movement of the ICR filter 106, the movement of the ICR filter 106 may be caused while the IR LEDs 104 are not illuminated (e.g., are not consuming any power).

To cause movement of the ICR filter 106 into the first position, the capability of the camera heater(s) 112 may be disabled. If the capability of the camera heater(s) 112 is disabled, the camera heater(s) 112 may be unable to generate heat. The capability of the camera heater(s) 112 may be disabled if the camera heater(s) 112 are currently generating heat or if the camera heater(s) 112 are not currently generating heat. If the camera heater(s) 112 are disabled, the camera heater(s) 112 may not draw any power (from the power source 112 and/or the battery 120). Disabling the camera heater(s) 112 may ensure that enough power is available to cause movement of the ICR filter 106.

The IR LEDs 104 may be de-illuminated (e.g., turned off). De-illumination of the IR LEDs 104 may be caused based on the camera heater(s) 112 being disabled. The ICR filter 106 may be moved into the first position. Movement of the ICR filter 106 into the first position may be caused based on the de-illumination of the IR LEDs 104. The capability of the camera heater(s) 112 may be re-enabled based on the movement of the ICR filter 106 into the first position. If the capability of the camera heater(s) 112 is enabled, the camera heater(s) 112 may be able to generate heat again.

To cause movement of the ICR filter 106 into the second position, the capability of the camera heater(s) 112 may be disabled. If the capability of the camera heater(s) 112 is disabled, the camera heater(s) 112 may be unable to generate heat. The capability of the camera heater(s) 112 may be disabled if the camera heater(s) 112 are currently generating heat or if the camera heater(s) 112 are not currently generating heat. If the camera heater(s) 112 are disabled, the camera heater(s) 112 may not draw any power (from the power source 112 and/or the battery 120). Disabling the camera heater(s) 112 may ensure that enough power is available to cause movement of the ICR filter 106 into the second position.

The ICR filter 106 may be moved into the second position. Movement of the ICR filter 106 into the second position may be caused based on the camera heater(s) 112 being disabled. The IR LEDs 104 may be illuminated. The IR LEDs 104 may be illuminated after the movement of the ICR filter 106 into the second position is complete. The capability of the camera heater(s) 112 may be re-enabled based on the IR LEDs 104 being illuminated. If the capability of the camera heater(s) 112 is enabled, the camera heater(s) 112 may be able to generate heat again.

The LEDs 109 may be configured to illuminate (e.g., display an animation). The LEDs 109 may be positioned anywhere on the housing of the doorbell device 101. For example, the LEDs 109 may be positioned around the button 108, around the camera 110, in between the button 108 and the camera 110, and/or any combination thereof. The LEDs 109 may be configured to illuminate in any color. The LEDs 109 may be configured to illuminate based on the occurrence of one or more events. The event may comprise an actuation of the button 108. Additionally, or alternatively, the event may comprise an indication that a visitor is approaching (e.g., walking up to) the doorbell device 101.

The LEDs 109 may require a large quantity of power (from the power source 118 and/or from the battery 120) to function properly (e.g., to illuminate). The LEDs 109 may be configured to draw power from the power source 118 and/or from the battery 120. Thus, if it is determined that the LEDs 109 are to illuminate, the camera heater(s) 112 may be disabled to ensure that enough power is available to illuminate LEDs 109.

It may be determined that the LEDs 109 are to illuminate. For example, it may be determined that the LEDs 109 are to illuminate based on the button 108 being actuated. Additionally, or alternatively, it may be determined that the LEDs 109 are to be illuminated based on a visitor approaching (e.g., walking up to) the doorbell device 101. If it is determined that the LEDs 109 are to illuminate, the capability of the camera heater(s) 112 may be disabled. If the capability of the camera heater(s) 112 is disabled, the camera heater(s) 112 may be unable to generate heat. The capability of the camera heater(s) 112 may be disabled if the camera heater(s) 112 are currently generating heat or if the camera heater(s) 112 are not currently generating heat. If the camera heater(s) 112 are disabled, the camera heater(s) 112 may not draw any power (from the power source 112 and/or the battery 120). Disabling the camera heater(s) 112 may ensure that enough power is available to illuminate LEDs 109. The capability of the camera heater(s) 112 may be re-enabled if the illumination of the LEDs 109 is complete. If the capability of the camera heater(s) 112 is enabled, the camera heater(s) 112 may be able to generate heat again.

The audio input(s) 114 may comprise one or more microphones. The audio input(s) 114 may be configured to generate audio data. The audio input(s) 114 may generate the audio data by capturing audio emanating from one or more audio sources. The audio source(s) may comprise anything (e.g., device, object, animal, etc.) or anyone (e.g., human) that is capable of outputting audio. The audio source(s) may be located outdoors at the premises, such as in front or proximate to the doorbell device 101. The audio source(s) may comprise, for example, a person that is standing in front of the doorbell device 101 and speaking.

The user device(s) 126 may comprise a computing device, such as, for example, a smart device (e.g., smart glasses, smart watch, smart phone), a mobile device, a tablet, a computing station, a laptop, a digital streaming device, a set-top box, a streaming stick, a television, and/or the like. In some scenarios, a user may have multiple user devices, such as a mobile phone, a smart watch, smart glasses, a combination thereof, and/or the like. The user device(s) 126 may be configured to communicate with the doorbell device 101, such as via the wireless communication module 122.

The user device(s) 126 may be configured to output a user interface on a display of the user device(s) 126. The display may comprise a television, screen, monitor, projector, and/or the like. The user interface may be output via the user interface via an application, service, and/or the like, such as a content browser. The user interface may comprise an application 128. The application 128 may be associated with the doorbell device 101. The application 128 may be configured to output camera data generated by the camera device 110 and/or audio data generated by the audio input(s) 114. For example, a live video or audio stream, video or audio clips, and/or images captured by the camera 110 and/or audio input(s) 114 may be output by the application 128 so that a user of the user device(s) 126 can monitor the premises, monitor who is standing in front of the camera 110, and/or monitor who has pressed the button 108.

The audio output(s) 116 may comprise one or more speakers. The audio output(s) 116 may be configured to output audio. The audio may include any audio, such as audible tones (e.g., beeps, etc.) or prestored messages. For example, the audio output(s) 116 may output a noise if a user presses the button 108. The audio output(s) 116 may be configured to output audio received from the user device(s) 126. For example, a user of the application 128 may utilize one or more audio inputs of the user device(s) 126 to capture audio (e.g., speech). Data indicative of the audio may be sent to (e.g., forwarded) to the processor 102. The processor 102 may cause output of the audio via the audio output(s) 116.

A connection (e.g., wireless connection and/or wired connection) may be established between the application 128 (e.g., the user device(s) 126) and the doorbell device 101. For example, a connection may be established between the application 128 (e.g., the user device(s) 126) and one or more of the components of the doorbell device 101, such as the processor 102, the camera 110, the audio input(s) 114, the audio output(s) 116, etc. The connection may be established by one or more of the application 128, the user device(s) 126, the doorbell device 101, or a remote server in communication with the application 128 and the doorbell device 101. The connection may facilitate live (e.g., real-time) communication between a first user associated with the user device(s) 126 and a second user. The second user may be an individual that is standing in front of the doorbell device 101 and/or an individual that has just pressed the button 108.

The connection may comprise a video channel, a data channel, a combination thereof (e.g., combined as one channel, or via two separate channels). The video channel (e.g., or a streaming channel, a media channel, an audio channel, a combined video and audio channel) may be configured to exchange audio, video, and/or image data between the application 128 and the doorbell device 101. Additionally, or alternatively, the connection may comprise an audio channel that is separate from the video channel. The video channel and/or audio channel may be utilized to send camera data and/or audio data generated by the camera 110 and the audio input(s) 114 to the user device(s) 126 for output by the application 128. The video channel and/or audio channel may be utilized to send audio data generated by the application 128 to the doorbell device 101 for output via the audio output(s) 116. The data channel may be configured to exchange any type of data, including data that is not audio data, video data, or image data between the application 128 and the doorbell device 101. The connection may comprise, for example, a peer-to-peer connection, such as a Web Real-Time Communication (WebRTC) connection.

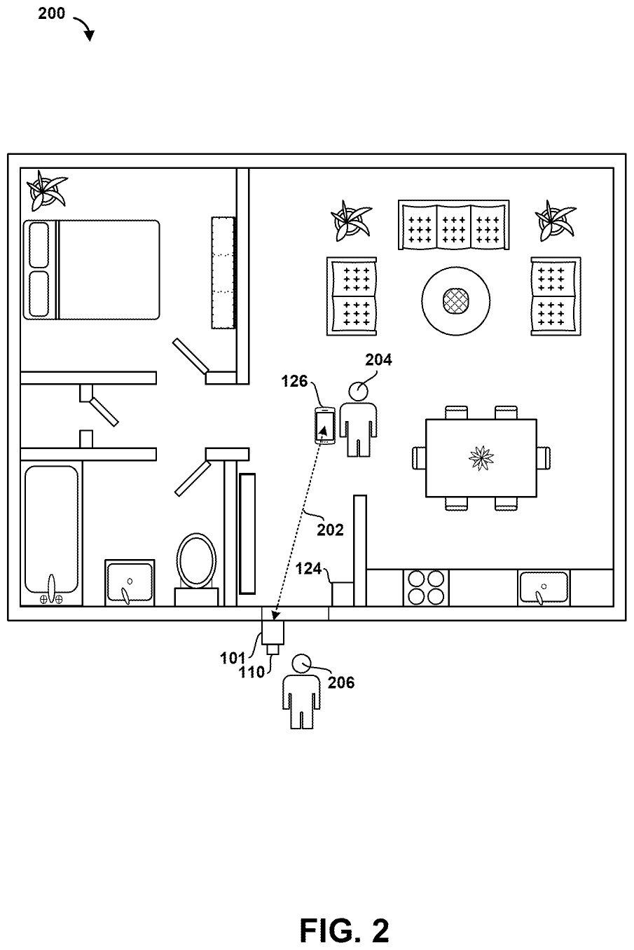

FIG. 2 shows an example environment 200. The environment 200 may comprise a connection 202. The connection 202 may be established between the doorbell device 101 and the user device 126. The connection 202 may be directly established between the doorbell device 101 and the user device 126, as shown in FIG. 2. The connection 202 may be established through the cloud. The connection 202 may comprise a video channel, a data channel, a combination thereof (e.g., combined as one channel, or via two separate channels). The video channel (e.g., or a streaming channel, a media channel, an audio channel, a combined video and audio channel) may be configured to exchange audio, video, and/or image data between the application 128 and the doorbell device 101. Additionally, or alternatively, the connection 202 may comprise an audio channel that is separate from the video channel. The video channel and/or audio channel may be utilized to send camera data and/or audio data generated by the camera 110 and the audio input(s) 114 to the user device(s) 126 for output by the application 128. The video channel and/or audio channel may be utilized to send audio data generated by the application 128 to the doorbell device 101 for output via the audio output(s) 116. The data channel may be configured to exchange any type of data, including data that is not audio data, video data, or image data between the application 128 and the doorbell device 101. The connection 202 may comprise, for example, a peer-to-peer connection, such as a Web Real-Time Communication (WebRTC) connection.

The connection 202 may facilitate live (e.g., real-time) communication between a first user 204 associated with the user device 126 and a second user 206. The first user 204 and the user device 126 may be located inside of a building, for example. The second user 206 may be an individual located outside of the building. The second user 206 may be standing in front of the doorbell device 101. The first user 204 may communicate with the second user 206 via the connection. The first user 204 may be able to see a real-time field of view of the camera 110 (which may include the second user 206) on an interface of an application (e.g., the application 128) installed on the user device 126. The first user 204 may be able to hear the second user 206 speaking in real time or near real time via the application. The second user 206 may additionally or alternatively be able to hear the first user 204 speaking in real time or near real time. For example, speech associated with the first user 204 may be output from the audio output(s) 116 of the doorbell device 101.

Referring back to FIG. 1, the power source 118 may provide power (e.g., AC power) to the doorbell device 101 until the button 108 is pressed (e.g., by a user). To cause the chime 124 to output an audio notification (e.g., if the button 108 is pressed), the doorbell device 101 may switch to temporarily relying on the battery 120 to power its components. If the doorbell device 101 is relying on the battery 120 for power, the doorbell device 101 may not draw power from the power source 118. The doorbell device 101 may temporarily rely on the battery 120 for power so that the power source 118 has the capacity to provide sufficient power to the chime 124 to cause the chime 124 to output an audio notification. The doorbell device 101 may switch back to relying on the power source 118 if output of the audio notification is complete. The battery 120 may be recharged based on the doorbell device 101 switching back to relying on the power source 118.

The battery 120 may not have the capacity to maintain a connection between the application 128 (e.g., the user device(s) 126) and the doorbell device 101 and power the speaker(s) 116. Thus, if causing the chime 124 to output an audio notification causes the doorbell device 101 to temporarily rely on battery power, it may be undesirable to cause the chime 124 to output an audio notification if a connection (e.g., two-way connection) is established between the application 128 (e.g., the user device(s) 126) and the doorbell device 101. If a connection (e.g., two-way connection) is established between the application 128 (e.g., the user device(s) 126) and the doorbell device 101, the doorbell device 101 may be prevented from switching to the battery 120 as a power source. For example, the doorbell device 101 may be prevented from switching from the power source 118 to the battery 120.

Preventing the doorbell device 101 from switching to the battery 120 as a power source may comprise disabling the chime 124. Disabling the chime 124 may prevent the chime 124 from outputting audio notifications. Preventing the chime from outputting audio notifications may be based on determining that the connection is established. For example, the chime may be prevented from outputting audio notifications regardless of whether the button 108 is actuated. If the chime 124 is prevented from outputting audio notifications, the chime 124 may not output audio notifications if the button 108 is actuated. A notification may still be sent to the user device(s) 126 if the button 108 is actuated. If the connection (e.g., two-way connection) is terminated, the chime 124 may be re-enabled to cause output of audio notifications (e.g., based on actuation of the button 108).

If the button 108 is actuated, outdoor feedback may be output. The outdoor feedback may be output via the doorbell device 101. The outdoor feedback may comprise illumination of the LEDS 109 and/or audio feedback (e.g., a noise, audio notification) output via the audio output(s) 116. Causing output of the outdoor feedback may require a large quantity of power. If causing the chime 124 to output an audio notification causes the doorbell device 101 to temporarily rely on battery power, the battery 120 may not have the capacity to power the camera 110, the camera heater(s) 112, and cause the outdoor feedback.

The capability of the camera heater(s) 112 may be disabled. The camera heater(s) 112 may be disabled based on the button 108 being actuated. If the capability of the camera heater(s) 112 is disabled, the camera heater(s) 112 may be unable to generate heat. The capability of the camera heater(s) 112 may be disabled if the camera heater(s) 112 are currently generating heat or if the camera heater(s) 112 are not currently generating heat. If the camera heater(s) 112 are disabled, the camera heater(s) 112 may not draw any power from the power source 118 or the battery 120.

Disabling the camera heater(s) 112 may ensure that enough power (e.g., AC power) is available to cause the outdoor feedback. The outdoor feedback may be caused. The outdoor feedback may be caused based on the capability of the camera heater(s) 112 being disabled. Causing the outdoor feedback may comprise causing illumination of the LEDs 109. Causing the outdoor feedback may additionally, or alternatively, comprise causing output of the audio feedback via the audio output(s) 116. The output of additional outdoor feedback may be disabled based on determining that the outdoor feedback is complete. Disabling the output of additional outdoor feedback may comprise disabling the output of additional audio via the audio output(s) 116. Disabling the output of additional outdoor feedback may comprise disabling the function of the LEDS 109.

Disabling the outdoor feedback may ensure that the audio output(s) 116 and/or the LEDs 109 do not draw any power from the battery 120 if the doorbell device 101 switches to battery power. The doorbell device 101 may switch from relying on the power source 118 to the battery 120 based on the output of additional outdoor feedback being disabled. The chime 124 may be caused to output an audio notification based on the doorbell device 101 switching from relying on the power source 118 to the battery 120. The doorbell device 101 may switch back to relying on the power source 118 if output of the audio notification is complete. The battery 120 may be recharged based on the doorbell device 101 switching back to relying on the power source 118. The output of additional outdoor feedback may be enabled based on the doorbell device 101 switching back to relying on the power source 118. If the output of additional outdoor feedback is enabled, the output of additional audio via the audio output(s) 116 and/or the function of the LEDs 109 may be enabled. The capability of the camera heater(s) 112 may be enabled based on the output of outdoor feedback being enabled. If the capability of the camera heater(s) 112 is enabled, the camera heater(s) 112 may be able to generate heat again.

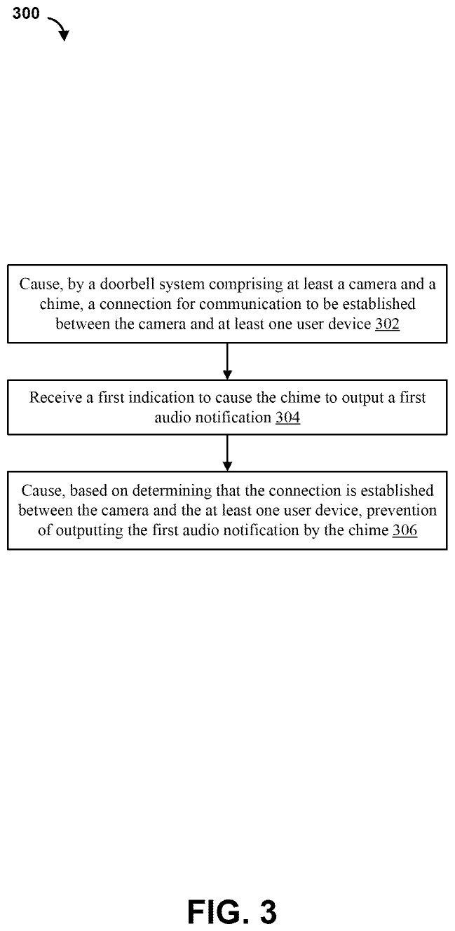

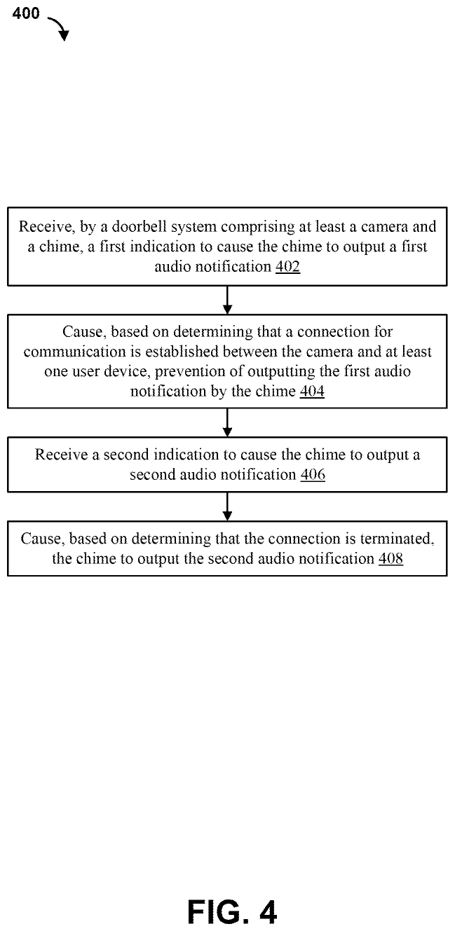

FIG. 3 shows an example method 300. The method 300 may be used to manage power for doorbell systems. The method 300 may be performed, for example, in connection with the system 100 of FIG. 1 and the framework 200 of FIG. 2. The method 300 may be performed, for example, by one or more components of the doorbell device 101 of FIG. 1 (e.g., the processor 102). Although depicted as a sequence of operations in FIG. 3, those of ordinary skill in the art will appreciate that various embodiments may add, remove, reorder, or modify the depicted operations. The method of FIG. 3 may be performed in any combination with the methods shown in FIGS. 4, 5, 6, 7, 8, and 9, described hereinafter.

At 302, a doorbell system may cause a connection to be established. The doorbell system may comprise at least a camera and a chime. The connection may comprise a connection for two-way communication. The connection may be caused to be established between the camera and at least one user device. The user device(s) may comprise an application. The application may be associated with the doorbell system. Causing the connection to be established between the camera and the user device(s) may comprise causing the connection to be established between the camera and the application.

The connection may facilitate live (e.g., real-time) communication between a first user associated with the user device(s) and a second user. The first user and the user device(s) may be located inside of a building, for example. The second user may be an individual located outside of the building. The second user may be standing in front of or proximate to the camera. The first user may communicate with the second user via the connection. The camera may be configured to exchange at least one of live audio data or live video data with the at least one user device (e.g., the application) via the connection. For example, the first user may be able to see a real-time field of view of the camera (which may include the second user) on an interface of the application. The first user may be able to hear the second user speaking (e.g., into one or more audio inputs associated with the camera) in real time or near real time via the application. The second user may additionally or alternatively be able to hear the first user speaking in real time or near real time. For example, speech associated with the first user may be output from one or more audio outputs associated with the camera.

The doorbell system may further comprise a button. To cause the chime to output an audio notification (e.g., if the button is pressed), the camera may switch to temporarily relying on a battery power source. If the camera is relying on the battery power source, the camera may not draw power from the AC power source. Thus, the AC power source may be able to provide sufficient power to cause the chime to output an audio notification. At 304, a first indication may be received. The first indication may comprise an indication to cause the chime to output a first audio notification. The first indication to cause the chime to output the first audio notification may comprise an indication that the button has been pressed.

The battery power source may not have the capacity to maintain the connection between the camera and the user device(s) and power the speaker(s) 116. Thus, if causing the chime to output an audio notification causes the camera to rely on the battery power source, it may be undesirable to cause the chime to output an audio notification when the connection is established between the camera and the user device(s). At 306, prevention of outputting the first audio notification by the chime may be caused. The chime may be prevented from outputting the first audio notification based on determining that the connection is established between the camera and the at least one user device. Preventing output of the first audio notification by the chime may comprise preventing an AC power source associated with the camera from being switched to a battery power source. If the chime is prevented from outputting the first audio notification, a notification of the first indication may still be sent to the user device(s).

The connection may be caused to be terminated. For example, the connection may be caused to be terminated based on the first user and/or the second user indicating that the communication is complete. If the connection is terminated, the camera may be enabled to switch to the battery power source. If the camera is able to switch to the battery power source, the chime may be able to cause output of audio notifications (e.g., based on the button being pressed). A second indication to cause the chime to output a second audio notification may be received. Based on receiving the second indication, an AC power source associated with the camera may be caused to be switched to the battery power source. The chime may be caused to output the second audio notification. For example, the chime may be caused to output the second audio notification based on the AC power source associated with the camera being switched to the battery power source.

FIG. 4 shows an example method 400. The method 400 may be used to manage power for doorbell systems. The method 400 may be performed, for example, in connection with the system 100 of FIG. 1 and the environment 200 of FIG. 2. The method 400 may be performed, for example, by one or more components of the doorbell device 101 of FIG. 1 (e.g., the processor 102). Although depicted as a sequence of operations in FIG. 4, those of ordinary skill in the art will appreciate that various embodiments may add, remove, reorder, or modify the depicted operations. The method of FIG. 4 may be performed in any combination with the methods shown in FIGS. 3, 5, 6, 7, 8, and 9.

A doorbell system may comprise a camera, a chime, and a button. To cause the chime to output an audio notification (e.g., if the button is pressed), the camera may switch from an AC power source to a battery power source. If the camera is relying on the battery power source, the camera may not draw power from the AC power source. Thus, the AC power source may be able to provide sufficient power to cause the chime to output an audio notification. At 402, a first indication may be received. The first indication may be received by the doorbell system. The first indication may comprise an indication to cause the chime to output a first audio notification. The first indication to cause the chime to output the first audio notification may comprise an indication that the button has been pressed at a first time.

At 404, prevention of outputting the first audio notification by the chime may be caused. The chime may be prevented from outputting the first audio notification based on determining that a connection is established between the camera and at least one user device. The connection may comprise a connection for two-way communication. The user device(s) may comprise an application. The application may be associated with the doorbell system. The connection may be established between the camera and the application.

The connection may facilitate live (e.g., real-time) communication between a first user associated with the user device(s) and a second user. The first user and the user device(s) may be located inside of a building, for example. The second user may be an individual located outside of the building. The second user may be standing in front of the camera. The first user may communicate with the second user via the connection. The camera may be configured to exchange at least one of live audio data or live video data with the at least one user device (e.g., the application) via the connection. For example, the first user may be able to see a real-time field of view of the camera (which may include the second user) on an interface of the application. The first user may be able to hear the second user speaking (e.g., into one or more audio inputs associated with the camera) in real time or near real time via the application. The second user may additionally or alternatively be able to hear the first user speaking in real time or near real time. For example, speech associated with the first user may be output from one or more audio outputs associated with the camera.

The connection may be terminated based on the first user and/or the second user indicating that the communication is complete. If the connection is terminated, the camera may be able to switch to the battery power source. If the camera is able to switch to the battery power source, the chime may be able to cause output of audio notifications (e.g., based on the button being pressed). At 406, a second indication may be received. The second indication may be received by the doorbell system. The second indication may comprise an indication to cause the chime to output a second audio notification. The second indication to cause the chime to output the second audio notification may comprise an indication that the button has been pressed at a second time. The second time may for example, occur after the first time. The second time may occur after the connection is terminated. At 408, the chime may be caused to output the second audio notification. The chime may be caused to output the second audio notification based on determining that the connection is terminated.

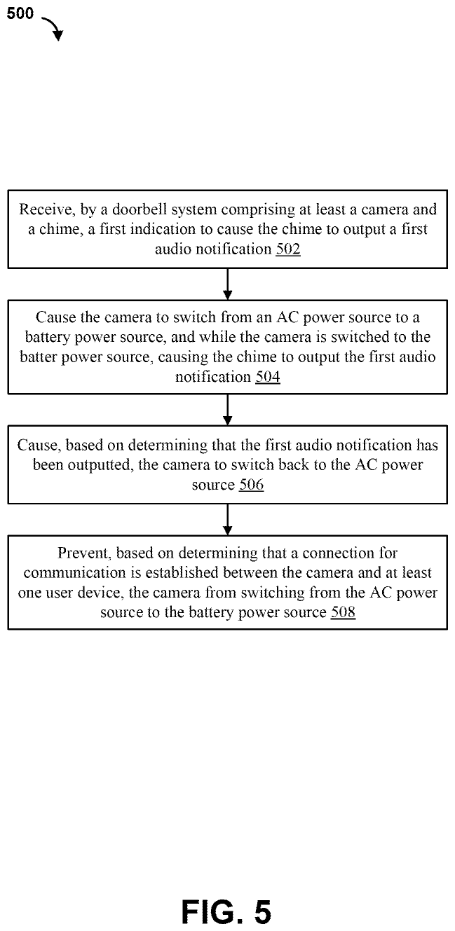

FIG. 5 shows an example method 500. The method 500 may be used to manage power for doorbell systems. The method 500 may be performed, for example, in connection with the system 100 of FIG. 1 and the architecture 200 of FIG. 2. The method 500 may be performed, for example, by one or more components of the doorbell device 101 of FIG. 1 (e.g., the processor 102). Although depicted as a sequence of operations in FIG. 5, those of ordinary skill in the art will appreciate that various embodiments may add, remove, reorder, or modify the depicted operations. The method of FIG. 5 may be performed in any combination with the methods shown in FIGS. 3, 4, 6, 7, 8, and 9.

A doorbell system may comprise a camera, a chime, and a button. At 502, a first indication may be received. The first indication may be received by the doorbell system. The first indication may comprise an indication to cause the chime to output a first audio notification. The first indication to cause the chime to output the first audio notification may comprise an indication that the button has been pressed at a first time.

To cause the chime to output the first audio notification, the camera may switch from an AC power source to a battery power source. If the camera is relying on the battery power source, the camera may not draw power from the AC power source. Thus, the AC power source may be able to provide sufficient power to cause the chime to output the first audio notification. At 504, the camera may be caused to be switched from an AC power source to a battery power source. While the camera is switched to the battery power source, the chime may be caused to output the first audio notification. The camera may switch back the AC power source if output of the audio notification is complete. At 506, the camera may be caused to switch back to the AC power source. The camera may be caused to switch back to the AC power source based on determining that the first audio notification has been output. The battery may be recharged based on the camera switching back to the AC power source.

A connection may be established between the camera and at least one user device. The connection may comprise a connection for two-way communication. The connection may facilitate live (e.g., real-time) communication between a first user associated with the user device(s) and a second user. The camera may be configured to exchange at least one of live audio data or live video data with the at least one user device via the connection. At 508, the camera may be prevented from switching from the AC power source to the battery power source. The camera may be prevented from switching from the AC power source to the battery power source based on determining that the connection is established between the camera and at least one user device.

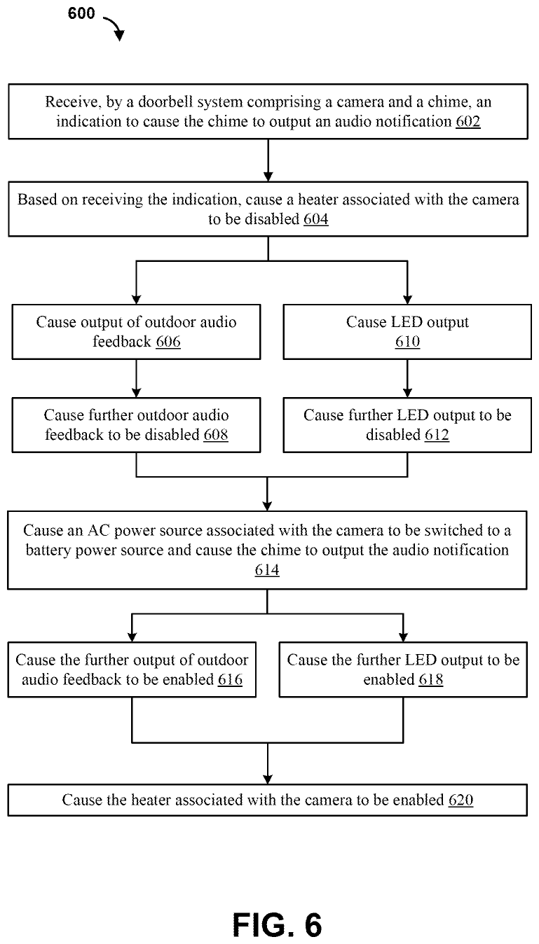

FIG. 6 shows an example method 600. The method 600 may be used to manage power for doorbell systems. The method 600 may be performed, for example, in connection with the system 100 of FIG. 1 and the architecture 200 of FIG. 2. The method 600 may be performed, for example, by one or more components of the doorbell device 101 of FIG. 1 (e.g., the processor 102). Although depicted as a sequence of operations in FIG. 6, those of ordinary skill in the art will appreciate that various embodiments may add, remove, reorder, or modify the depicted operations. The method of FIG. 6 may be performed in any combination with the methods shown in FIGS. 3, 4, 5, 7, 8, and 9.

A doorbell system may comprise a camera, a chime, and a button. At 602, an indication may be received. The indication may be received by the doorbell system. The indication may comprise an indication to cause the chime to output an audio notification. The indication to cause the chime to output the audio notification may comprise an indication that the button has been pressed. To cause the chime to output the audio notification, the camera may switch from an AC power source to a battery power source. If the camera is relying on the battery power source, the camera may not draw power from the AC power source. Thus, the AC power source may be able to provide sufficient power to cause the chime to output the first audio notification.

Output of outdoor feedback may be caused based on receiving the indication. The outdoor feedback may comprise illumination of LEDs associated with the camera. The outdoor feedback may additionally, or alternatively, comprise audio feedback (e.g., a noise, audio notification) output via one or more audio outputs associated with the camera. However, causing output of the outdoor feedback may require a large quantity of power. The battery power source may not have the capacity to power the camera, one or more camera heater(s), and cause the outdoor feedback.

The capability of the camera heater(s) may be disabled. At 604, a heater associated with the camera may be caused to be disabled. The heater associated with the camera may be caused to be disabled based on receiving the indication. If the capability of the camera heater(s) is disabled, the camera heater(s) may be unable to generate heat. The capability of the camera heater(s) may be disabled if the camera heater(s) are currently generating heat or if the camera heater(s) are not currently generating heat. If the camera heater(s) are disabled, the camera heater(s) may not draw any power (from the AC power source of the battery power source).

Disabling the camera heater(s) may ensure that enough AC power is available to cause the outdoor feedback (e.g., the audio feedback and/or the LED illumination). At 606, output of audio feedback may be caused. The output of the audio feedback may be caused based on the capability of the camera heater(s) being disabled. Causing the output of the audio feedback may comprise causing output of audio feedback via the audio output(s) associated with the camera. The output of additional audio feedback may be disabled based on determining that the output of the audio feedback is complete. At 608, further output of audio feedback may be caused to be disabled. Disabling the output of additional audio feedback may comprise disabling the output of additional audio via the audio output(s) associated with the camera.

At 610, LED output (e.g., illumination) may be caused. The LED output may be caused based on the capability of the camera heater(s) being disabled. Causing the LED output may comprise causing illumination and/or animation of the LEDs associated with the camera. The output of additional LED output may be disabled based on determining that the LED output is complete. At 612, further LED output may be caused to be disabled. Disabling further LED output may comprise disabling or preventing further illumination of the LEDs associated with the camera.

The camera may switch from relying on the AC power source to the battery power source based on the output of additional outdoor feedback being disabled. At 614, an AC power source associated with the camera may be caused to be switched to a battery power source. The chime may be caused to output the audio notification. The camera may switch back to relying on the AC power source if output of the audio notification is complete. The battery power source may be recharged based on the camera switching back to relying on the AC power source.

The output of additional outdoor feedback may be enabled based on the camera switching back to relying on the AC power source. At 616, the further output of audio feedback may be caused to be enabled. At 618, the further LED output may be caused to be enabled. The capability of the camera heater(s) may be enabled based on the output of outdoor feedback being enabled. At 620, the heater associated with the camera may be caused to be enabled. If the capability of the camera heater(s) is enabled, the camera heater(s) may be able to generate heat again.

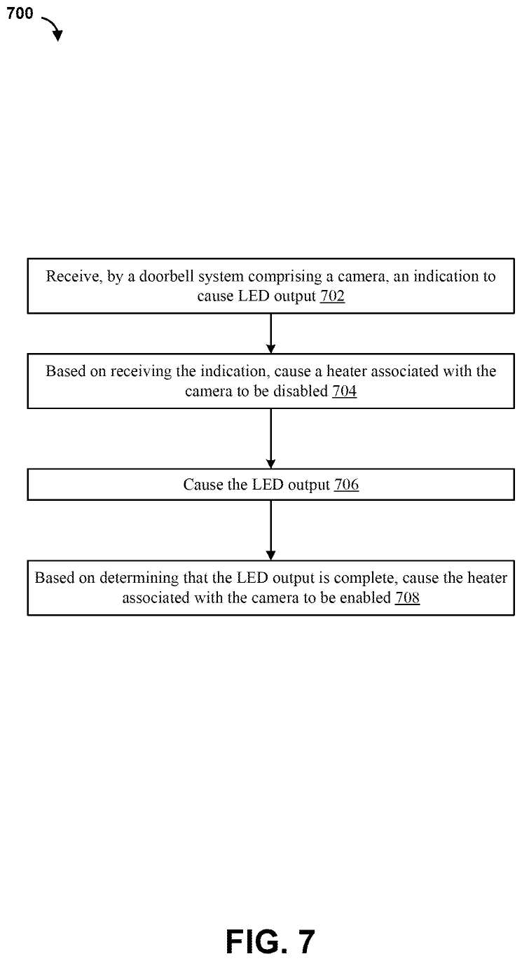

FIG. 7 shows an example method 700. The method 700 may be used to manage power for doorbell systems. The method 700 may be performed, for example, in connection with the system 100 of FIG. 1 and the architecture 200 of FIG. 2. The method 700 may be performed, for example, by one or more components of the doorbell device 101 of FIG. 1 (e.g., the processor 102). Although depicted as a sequence of operations in FIG. 7, those of ordinary skill in the art will appreciate that various embodiments may add, remove, reorder, or modify the depicted operations. The method of FIG. 7 may be performed in any combination with the methods shown in FIGS. 3, 4, 5, 6, 8, and 9.

A doorbell system may comprise a camera, a chime, and a button. The camera may be associated with one or more LEDs. The LEDs may be configured to illuminate (e.g., display an animation). The LEDs may be configured to illuminate based on the occurrence of one or more events. The event may comprise an actuation of the button. Additionally, or alternatively, the event may comprise an indication that a visitor is approaching (e.g., walking up to) the camera. At 702, an indication to cause LED output may be received. The LED output may comprise illumination or animation of the LEDs. The indication to cause the LED output may comprise an indication of an actuation of the button. Additionally, or alternatively, the indication to cause the LED output may comprise an indication that a visitor is approaching (e.g., walking up to) the camera

The LEDs may require a large quantity of power (from an AC power source and/or from a battery power source) to function properly (e.g., to illuminate). Thus, if it is determined that the LEDs are to illuminate, one or more heaters associated with the camera may be disabled to ensure that enough power is available to illuminate LEDs. At 704, a heater associated with the camera may be caused to be disabled. The heater associated with the camera may be caused to be disabled based on receiving the indication to cause LED output.

If the capability of the camera heater(s) is disabled, the camera heater(s) may be unable to generate heat. The capability of the camera heater(s) may be disabled if the camera heater(s) are currently generating heat or if the camera heater(s) are not currently generating heat. If the camera heater(s) are disabled, the camera heater(s) may not draw any power (from the power source and/or the battery). Disabling the camera heater(s) may ensure that enough power is available to illuminate LEDs. At 706, the LED output may be caused. The capability of the camera heater(s) may be re-enabled if the illumination of the LEDs is complete. At 708, the heater associated with the camera may be caused to be enabled. The heater associated with the camera may be caused to be enabled based on determining that the LED output is complete. If the capability of the camera heater(s) is enabled, the camera heater(s) may be able to generate heat again.

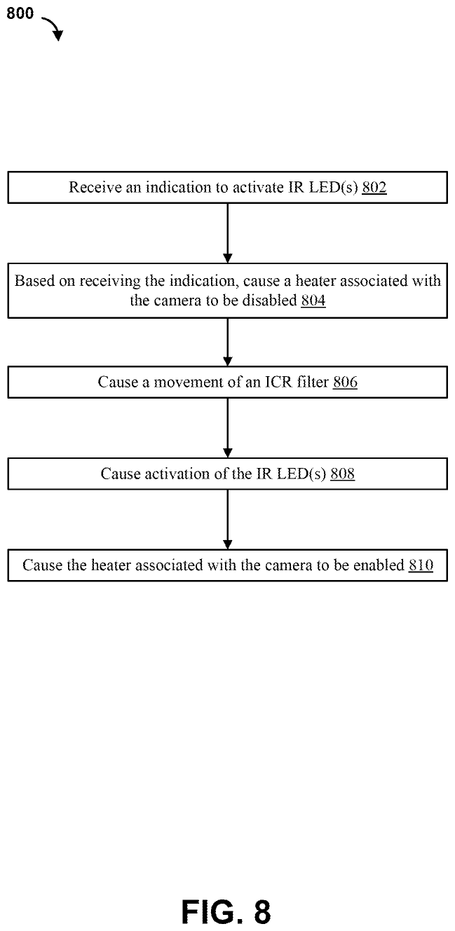

FIG. 8 shows an example method 800. The method 800 may be used to manage power for doorbell systems. The method 800 may be performed, for example, in connection with the system 100 of FIG. 1 and the architecture 200 of FIG. 2. The method 800 may be performed, for example, by one or more components of the doorbell device 101 of FIG. 1 (e.g., the processor 102). Although depicted as a sequence of operations in FIG. 8, those of ordinary skill in the art will appreciate that various embodiments may add, remove, reorder, or modify the depicted operations. The method of FIG. 8 may be performed in any combination with the methods shown in FIGS. 3, 4, 5, 6, 7, and 9.

A doorbell system may comprise a camera, a chime, and a button. The camera may be associated with one or more IR LEDs. The camera may be associated with an ICR filter. The ICR filter may be a physical filter configured to block out infrared light. The ICR filter may be physically moved into a first position or a second position. In the second position, the ICR filter is not positioned between the lens of the camera and the image sensor of the camera. The ICR filter may be moved into the second position if it is determined that level of natural light has fallen below (e.g., does not satisfy) the predetermined threshold (e.g., if it is determined that it is nighttime). If the ICR filter is in the second position, the ICR filter may not be configured to block (e.g., filter) out infrared light that enters through the lens of the camera.

Causing movement of the ICR filter (e.g., to the second position) may require a large quantity of power. The power may be drawn from an AC power source and/or a battery power source. To ensure that enough power is available to cause movement of the ICR filter to the second position, the capability of one or more heater(s) associated with the camera may be disabled. Additionally, or alternatively, to ensure that enough power is available to cause movement of the ICR filter to the second position, the movement of the ICR filter may be caused before the IR LEDs are illuminated (e.g., before the IR LEDs begin consuming any power).

At 802, an indication to activate the IR LEDs may be received. Activating the IR LEDs may comprise illuminating the IR LEDs. The indication may comprise an indication that a level of natural light has fallen below (e.g., does not satisfy) a predetermined threshold. For example, the indication may comprise an indication that it is nighttime. At 804, a heater associated with the camera may be caused to be disabled. The heater associated with the camera may be caused to be disabled based on receiving the indication to activate the IR LEDs.

If the capability of the camera heater(s) is disabled, the camera heater(s) may be unable to generate heat. The capability of the camera heater(s) may be disabled if the camera heater(s) are currently generating heat or if the camera heater(s) are not currently generating heat. If the camera heater(s) are disabled, the camera heater(s) may not draw any power (from the power source and/or the battery). Disabling the camera heater(s) may ensure that enough power is available to cause movement of the ICR filter to the second position. At 806, movement of the ICR filter may be caused. The movement of the ICR filter may comprise a movement of the ICR filter into the second position. Movement of the ICR filter into the second position may be caused based on the camera heater(s) being disabled.

At 808, activation of the IR LEDs may be caused. Causing activation of the IR LEDs may comprise causing illumination of the IR LEDs. Activation of the IR LEDs may be caused based on determining that the movement of the ICR filter into the second position is complete. The capability of the camera heater(s) may be re-enabled based on the IR LEDs being illuminated. At 810, the heater associated with the camera may be caused to be enabled. If the capability of the camera heater(s) is enabled, the camera heater(s) may be able to generate heat again.

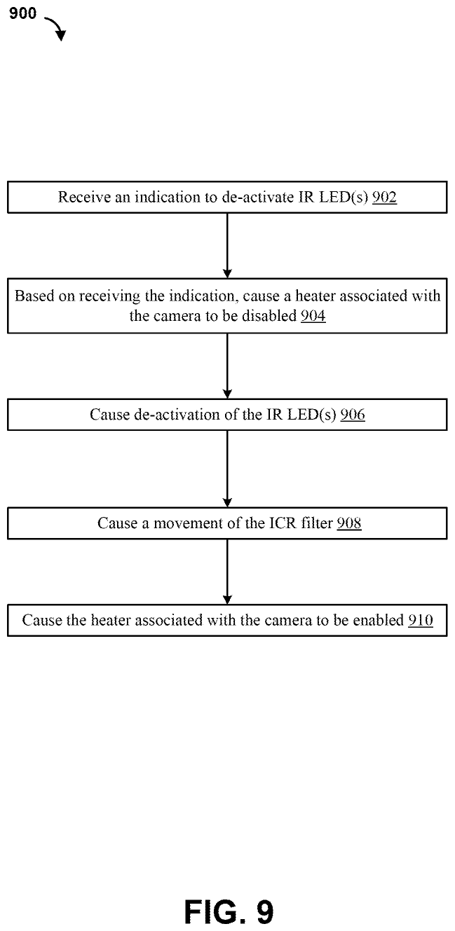

FIG. 9 shows an example method 900. The method 900 may be used to manage power for doorbell systems. The method 900 may be performed, for example, in connection with the system 100 of FIG. 1 and the architecture 200 of FIG. 2. The method 900 may be performed, for example, by one or more components of the doorbell device 101 of FIG. 1 (e.g., the processor 102). Although depicted as a sequence of operations in FIG. 9, those of ordinary skill in the art will appreciate that various embodiments may add, remove, reorder, or modify the depicted operations. The method of FIG. 9 may be performed in any combination with the methods shown in FIGS. 3, 4, 5, 6, 7, and 8.

A doorbell system may comprise a camera, a chime, and a button. The camera may be associated with one or more IR LEDs. The camera may be associated with an ICR filter. The ICR filter may be a physical filter configured to block out infrared light. The ICR filter may be physically moved into a first position or a second position. In the first position, the ICR filter may be positioned between a lens of the camera and an image sensor of the camera. The ICR filter may be moved into the first position if it is determined that a level of natural light meets or exceeds the predetermined threshold (e.g., if it is determined that it is daytime). If the ICR filter is in the first position, the ICR filter may be configured to block (e.g., filter) out infrared light that enters through the lens of the camera.

Causing movement of the ICR filter (e.g., to the first position) may require a large quantity of power. The power may be drawn from an AC power source and/or a battery power source. To ensure that enough power is available to cause movement of the ICR filter to the first position, the capability of one or more heater(s) associated with the camera may be disabled. Additionally, or alternatively, to ensure that enough power is available to cause movement of the ICR filter to the first position, the movement of the ICR filter may be caused after the IR LEDs are de-illuminated (e.g., when the IR LEDs are no longer consuming any power).

At 902, an indication to de-activate the IR LEDs may be received. De-activating the IR LEDs may comprise de-illuminating (e.g., turning off) the IR LEDs. The indication may comprise an indication that a level of natural light meets or exceeds (e.g., satisfies) a predetermined threshold. For example, the indication may comprise an indication that it is daytime. At 904, a heater associated with the camera may be caused to be disabled. The heater associated with the camera may be caused to be disabled based on receiving the indication to de-activate the IR LEDs.

If the capability of the camera heater(s) is disabled, the camera heater(s) may be unable to generate heat. The capability of the camera heater(s) may be disabled if the camera heater(s) are currently generating heat or if the camera heater(s) are not currently generating heat. If the camera heater(s) are disabled, the camera heater(s) may not draw any power (from the power source and/or the battery). Disabling the camera heater(s) may ensure that enough power is available to cause movement of the ICR filter to the first position.

At 906, de-activation of the IR LEDs may be caused. Causing de-activation of the IR LEDs may comprise causing de-illumination of (e.g., turning off) the IR LEDs. De-activation of the IR LEDs may be caused based on determining that the camera heater(s) are disabled. At 908, movement of the ICR filter may be caused. The movement of the ICR filter may comprise a movement of the ICR filter into the first position. Movement of the ICR filter into the first position may be caused based on the de-activation of the IR LEDs. The capability of the camera heater(s) may be re-enabled based on the movement of the ICR filter into the first position. At 910, the heater associated with the camera may be caused to be enabled. If the capability of the camera heater(s) is enabled, the camera heater(s) may be able to generate heat again.

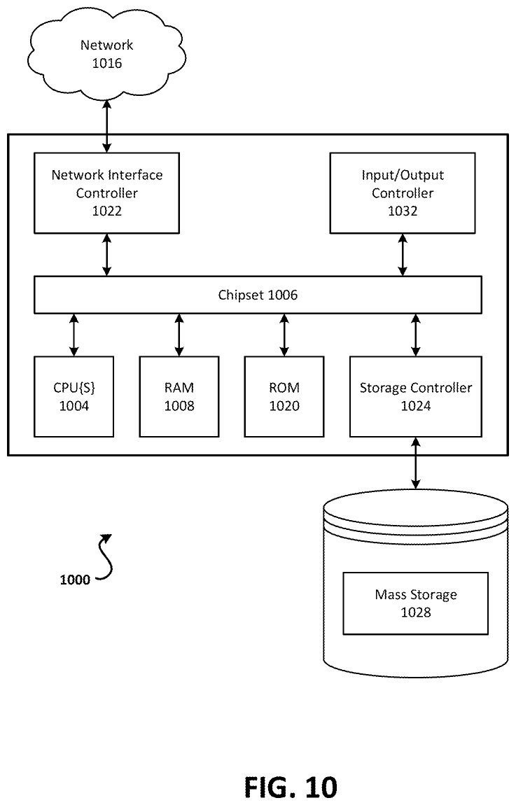

FIG. 10 shows a computing device 1000 that may be used in various aspects, such as the servers, modules, and/or devices depicted in FIG. 1. With regard to the example architecture of FIG. 1, one or more components of the doorbell device 101, the chime 124, or the user device(s) 126 may each be implemented in an instance of a computing device 1000 of FIG. 10. The computer architecture shown in FIG. 10 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIGS. 3-9.

The computing device 1000 may include a baseboard, or “motherboard,” which is a printed circuit board to which a multitude of components or devices may be connected by way of a system bus or other electrical communication paths. One or more central processing units (CPUs) 1004 may operate in conjunction with a chipset 1006. The CPU(s) 1004 may be standard programmable processors that perform arithmetic and logical operations necessary for the operation of the computing device 1000.

The CPU(s) 1004 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1004 may be augmented with or replaced by other processing units, such as GPU(s) 1005. The GPU(s) 1005 may comprise processing units specialized for but not necessarily limited to highly parallel computations, such as graphics and other visualization-related processing.

A chipset 1006 may provide an interface between the CPU(s) 1004 and the remainder of the components and devices on the baseboard. The chipset 1006 may provide an interface to a random access memory (RAM) 1008 used as the main memory in the computing device 1000. The chipset 1006 may provide an interface to a computer-readable storage medium, such as a read-only memory (ROM) 1020 or non-volatile RAM (NVRAM) (not shown), for storing basic routines that may help to start up the computing device 1000 and to transfer information between the various components and devices. ROM 1020 or NVRAM may also store other software components necessary for the operation of the computing device 1000 in accordance with the aspects described herein.

The computing device 1000 may operate in a networked environment using logical connections to remote computing nodes and computer systems through local area network (LAN) 1016. The chipset 1006 may include functionality for providing network connectivity through a network interface controller (NIC) 1022, such as a gigabit Ethernet adapter. A NIC 1022 may be capable of connecting the computing device 1000 to other computing nodes over a network 1016. It should be appreciated that multiple NICs 1022 may be present in the computing device 1000, connecting the computing device to other types of networks and remote computer systems.

The computing device 1000 may be connected to a mass storage device 1028 that provides non-volatile storage for the computer. The mass storage device 1028 may store system programs, application programs, other program modules, and data, which have been described in greater detail herein. The mass storage device 1028 may be connected to the computing device 1000 through a storage controller 1024 connected to the chipset 1006. The mass storage device 1028 may consist of one or more physical storage units. A storage controller 1024 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1000 may store data on a mass storage device 1028 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1028 is characterized as primary or secondary storage and the like.

For example, the computing device 1000 may store information to the mass storage device 1028 by issuing instructions through a storage controller 1024 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1000 may read information from the mass storage device 1028 by detecting the physical states or characteristics of one or more particular locations within the physical storage units.

In addition to the mass storage device 1028 described herein, the computing device 1000 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1000.

By way of example and not limitation, computer-readable storage media may include volatile and non-volatile, transitory computer-readable storage media and non-transitory computer-readable storage media, and removable and non-removable media implemented in any method or technology. However, as used herein, the term computer-readable storage media does not encompass transitory computer-readable storage media, such as signals. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1028 depicted in FIG. 10, may store an operating system utilized to control the operation of the computing device 1000. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 1028 may store other system or application programs and data utilized by the computing device 1000.

The mass storage device 1028 or other computer-readable storage media may also be encoded with computer-executable instructions, which, when loaded into the computing device 1000, transforms the computing device from a general-purpose computing system into a special-purpose computer capable of implementing the aspects described herein. These computer-executable instructions transform the computing device 1000 by specifying how the CPU(s) 1004 transition between states, as described herein. The computing device 1000 may have access to computer-readable storage media storing computer-executable instructions, which, when executed by the computing device 1000, may perform the methods described in relation to FIGS. 6-7.

A computing device, such as the computing device 1000 depicted in FIG. 10, may also include an input/output controller 1032 for receiving and processing input from a number of input devices, such as a keyboard, a mouse, a touchpad, a touch screen, an electronic stylus, or other type of input device. Similarly, an input/output controller 1032 may provide output to a display, such as a computer monitor, a flat-panel display, a digital projector, a printer, a plotter, or other type of output device. It will be appreciated that the computing device 1000 may not include all of the components shown in FIG. 10, may include other components that are not explicitly shown in FIG. 10, or may utilize an architecture completely different than that shown in FIG. 10.

As described herein, a computing device may be a physical computing device, such as the computing device 1000 of FIG. 10. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes¬ from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
causing, by a doorbell system comprising at least a camera and a chime, a connection for communication to be established between the camera and at least one user device;
receiving a first indication to cause the chime to output a first audio notification; and
causing, based on determining that the connection is established between the camera and the at least one user device, prevention of outputting the first audio notification by the chime.

2. The method of claim 1, wherein the at least one user device comprises an application associated with the doorbell system, and wherein causing the connection for communication to be established between the camera and the at least one user device comprises causing the connection to be established between the camera and the application.

3. The method of claim 1, wherein the doorbell system further comprises a button, and wherein the first indication to cause the chime to output the first audio notification comprises an indication that the button has been pressed.

4. The method of claim 1, wherein prevention of outputting the first audio notification by the chime comprises preventing an AC power source associated with the camera from being switched to a battery power source.

5. The method of claim 1, further comprising sending, based on receiving the first indication to cause the chime to output the first audio notification, a notification of the first indication to the at least one user device.

6. The method of claim 1, further comprising:
causing the connection to be terminated;
receiving a second indication to cause the chime to output a second audio notification; and
based on receiving the second indication, causing an AC power source associated with the camera to be switched to a battery power source and causing the chime to output the second audio notification.

7. The method of claim 1, wherein the camera is configured to exchange at least one of live audio data or live video data with the at least one user device via the connection.

8. A method comprising:
receiving, by a doorbell system comprising at least a camera and a chime, a first indication to cause the chime to output a first audio notification;
causing, based on determining that a connection for communication is established between the camera and at least one user device, prevention of outputting the first audio notification by the chime;
receiving a second indication to cause the chime to output a second audio notification; and
causing, based on determining that the connection is terminated, the chime to output the second audio notification.

9. The method of claim 8, wherein the at least one user device comprises an application associated with the doorbell system, and wherein determining that the connection for communication is established between the camera associated with the doorbell system and the at least one user device comprises determining that the connection is established between the camera and the application.

10. The method of claim 8, wherein the doorbell system further comprises a button, wherein the first indication to cause the chime to output the first audio notification comprises an indication that the button has been pressed at a first time, and wherein the second indication to cause the chime to output the second audio notification comprises an indication that the button has been pressed at a second time.

11. The method of claim 8, wherein causing prevention of outputting the first audio notification by the chime comprises preventing an AC power source associated with the camera from being switched to a battery power source.

12. The method of claim 8, further comprising sending, based on receiving the first indication to cause the chime to output the first audio notification, a notification of the first indication to the at least one user device.

13. The method of claim 8, wherein the camera is configured to exchange at least one of live audio data or live video data with the at least one user device via the connection.

14. A method comprising:
receiving, by a doorbell system comprising at least a camera and a chime, a first indication to cause the chime to output a first audio notification;
causing the camera to switch from an AC power source to a battery power source, and while the camera is switched to the battery power source, causing the chime to output the first audio notification;
causing, based on determining that the first audio notification has been outputted, the camera to switch back to the AC power source; and
preventing, based on determining that a connection for communication is established between the camera and at least one user device, the camera from switching from the AC power source to the battery power source.

15. The method of claim 14, wherein the at least one user device comprises an application associated with the doorbell system, and wherein determining that the connection for communication is established between the camera and at least one user device comprises determining that the connection is established between the camera and the application.

16. The method of claim 14, wherein the doorbell system further comprises a button, and wherein the first indication to cause the chime to output the first audio notification comprises an indication that the button has been pressed.

17. The method of claim 14, wherein preventing the camera from switching from the AC power source to the battery power source comprises preventing the chime from outputting additional audio notifications.

18. The method of claim 14, further comprising:
determining that the connection is terminated;
receiving a second indication to cause the chime to output a second audio notification; and
based on receiving the second indication, causing the AC power source associated with the camera to be switched to the battery power source and causing the chime to output the second audio notification.

19. The method of claim 14, wherein the camera is configured to exchange at least one of live audio data or live video data with the at least one user device via the connection.

20. The method of claim 14, further comprising sending, while the connection for communication is established between the camera and at least one user device, a notification of a second indication to cause the chime to output a second audio notification to the at least one user device.
